(19) United States
(12) Patent Application Publication
(10) Pub. No.: US 2023/0063057 A1
(43) Pub. Date: Mar. 2, 2023

(54) MEMORY ACCESS MANAGMENT

(71) Applicant: Micron Technology, Inc., Boise, ID (US)

(72) Inventors: Eric N. Lee, San Jose, CA (US); Robert W. Strong, Folsom, CA (US); William Akin, Morgan Hill, CA (US); Jeremy Binfet, Boise, ID (US)

(21) Appl. No.: 17/458,835

(22) Filed: Aug. 27, 2021

(51) Int. Cl. G06F 3/06

(52) U.S. Cl. CPC G06F 3/0652; G06F 3/0632; G06F 3/064; G06F 3/0679; G06F 3/0604

(57) ABSTRACT

A method includes detecting an occurrence of an event associated with a memory sub-system comprising blocks of non-volatile memory cells. The method further includes responsive to detecting the occurrence of the event, providing signaling to disable at least a portion of the memory sub-system, an interface coupled to the memory sub-system, or both.

### TECHNICAL FIELD

Embodiments of the disclosure relate generally to memory sub-systems, and more specifically, relate to memory access management.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure,

FIG. 1 illustrates an example computing system that includes a memory sub-system in accordance with some embodiments of the present disclosure.

FIG. 2 illustrates another example computing system that includes a memory sub-system in accordance with some embodiments of the present disclosure.

FIG. 3 illustrates an example flow diagram of memory access management in accordance with some embodiments of the present disclosure.

FIG. 4 illustrates an example method for memory access management in accordance with embodiments of the present disclosure.

FIG. 5 is a block diagram of an example computer system in which embodiments of the present disclosure may operate.

### DETAILED DESCRIPTION

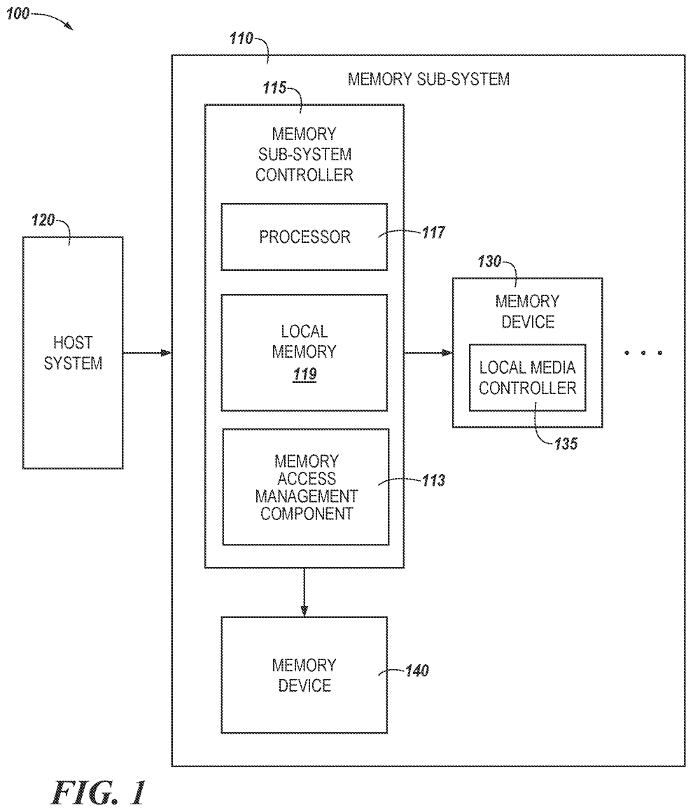

Aspects of the present disclosure are directed to memory access management, in particular to memory sub-systems that include a memory access management component. A memory sub-system can be a storage device, a memory module, or a hybrid of a storage device and memory module. An example of a memory sub-system is a storage system, such as a solid state drive (SDD). Examples of storage devices and memory modules are described below in conjunction with FIG. 1. In general, a host system can utilize a memory sub-system that includes one or more components, such as “memory devices” that store data. The host system can provide data to be stored at the memory sub-system and can request data to be retrieved from the memory sub-system.

A memory device can be a non-volatile memory device. One example of non-volatile memory devices is a negative-and (NAND) memory device (also known as flash technology). Other examples of non-volatile memory devices are described below in conjunction with FIG. 1. A non-volatile memory device is a package of one or more dice. Each die can consist of one or more planes. Planes can be groups into logic units (LUN). For some types of non-volatile memory devices (e.g., NAND devices), each plane consists of a set of physical blocks. Each block consists of a set of pages. Each page consists of a set of memory cells (“cells”). A cell is an electronic circuit that stores information. A block hereinafter refers to a unit of the memory device used to store data and can include a group of memory cells, a word line group, a word line, or individual memory cells. For some memory devices, blocks (also hereinafter referred to as “memory blocks”) are the smallest area than can be erased. Pages cannot be erased individually, and only whole blocks can be erased.

Each of the memory devices can include one or more arrays of memory cells. Depending on the cell type, a cell can be written to in order to store one or more bits of binary information, and has various logic states that correlate to the number of bits being stored. The logic states can be represented by binary values, such as “0” and “1”, or combinations of such values. There are various types of cells, such as single level cells (SLCs), multi-level cells (MLCs), triple level cells (TLCs), and quad-level cells (QLCs). For example, a SLC can store one bit of information and has two logic states.

Some NAND memory devices employ a floating-gate architecture in which memory accesses are controlled based on a relative voltage change between the bit line and the word lines. Other examples of NAND memory devices can employ a replacement-gate architecture that can include the use of word line layouts that can allow for charges corresponding to data values to be trapped within memory cells based on properties of the materials used to construct the word lines.

Performance of a NAND memory device can be determined by the program speed of the NAND memory device. That is, the speed at which it takes to program the pages of a NAND memory device. Systems can improve performance by grouping multiple NAND pages together in order to program the NAND pages concurrently. For instance, superblocks can be formed to increase system performance. A superblock, as used herein, can refer to a set of blocks that span multiple die that are written in an interleaved fashion. In some cases, a superblock may span all the die within an SSD. A superblock may contain multiple blocks from a single die. A superblock may be a unit of management within the SSD.

Protecting data on a non-volatile memory device such as a NAND memory device from any unintended or nefarious use is desired in various instances. For instance, it may be desirable to protect data on a non-volatile memory device during transit along a supply chain (e.g., between a manufacturer, a distributor, and/or an end-user), during an operational lifetime of the non-volatile memory device, and/or at the end of an operational lifetime of the non-volatile memory device.

Some efforts to protect data rely on physical destruction of the non-volatile memory device and/or erasing the data. Physical destruction renders the non-volatile memory device no longer reliable for storing and retrieving data by way of physical damage. Yet, physical destruction may not always be permissible or desired. For instance, physical destruction of a stolen or lost device may not be possible. Moreover, physical destruction is irreversible and therefore any further use of the non-volatile memory device is not possible once physically destroyed. In addition, physical destruction of a non-volatile memory device can have undesirable environmental impacts if not disposed of in an environmentally friendly manner.

As such, some approaches can perform an erase operation (e.g., a block erase) in an effort to erase and thereby protect (or at least render inaccessible) any data on the non-volatile memory device from an unintended access of the data. However, performance of an erase operation may be time-consuming and/or may not always be successful in erasing the data. As a result of being time-consuming and/or not successfully erasing the data, the data on the non-volatile memory device can remain accessible for an amount of time sufficient for an unauthorized and/or nefarious entity to gain access to the data. Moreover, an erase operation traditionally requires some initiation input and therefore does not initially or as a default protect data on the non-volatile memory device. For instance, data such as manufacturer specific data on the non-volatile memory device can be vulnerable to attack and/or corruption during transit along a supply chain and/or when a device in which the non-volatile memory device is included is lost/stolen. As such, an erase operation that relies on a traditional initiation input (e.g., a manual input to a device) may thereby not permit execution of an erase operation (e.g., in an instance when a device is lost/stolen).

Aspects of the present disclosure address the above and other deficiencies by allowing for performance of memory access management. Memory access management can include detecting an occurrence of an event associated with a memory sub-system comprising blocks of non-volatile memory cells, and responsive to detecting the occurrence of the event, providing signaling to disable at least a portion of the memory sub-system, an interface coupled to the memory sub-system, or both. For instance, an occurrence of a power-up event (e.g., initiation of a power-up event) can be detected, as detailed herein, and responsive to detection of the occurrence of the power-up event, signaling can be provided to disable at least a portion of the memory sub-system, the interface coupled to the memory sub-system, or both.

By disabling at least a portion of the memory sub-system, the interface coupled to the memory sub-system, or both, unwanted access to the blocks of non-volatile memory cells can be prevented. Preventing access can include preventing read, write, and/or erase access. For instance, preventing access can include preventing read, mite, and/or erase access to each of (or a subset of) the blocks of non-volatile memory cells in a memory sub-system, as detailed herein.

Use of memory access management provides additional benefits to non-volatile memory devices in a number of ways. For example, memory access management can occur in the absence of signaling indicative of an erase operation to ensure that access to data on the memory sub-system is timely prevented, as compared to other approaches that do not employ memory access management, such as those that may instead attempt to prevent access to the data by performing a time-consuming erase operation (e.g., a block erase) of any data on the non-volatile memory array. For instance, detection of an event and subsequent disabling of at least a portion of a memory sub-system and/or an interface coupled to the memory sub-system can occur in the absence of signaling indicative of an erase operation. Thus, memory access management can, in contrast to other approaches such as those that employ physical destruction and/or time-consuming erase operations instead timely prevent access to any data in the memory sub-system.

Further still, memory access management can, in some embodiments, be employed to prevent access to non-volatile memory cells, and yet subsequent access to the non-volatile memory cells can be reenabled. For instance, non-volatile memory cells in a memory sub-system in a lost/stolen device can be reenabled when the lost/stolen device is recovered, among other possibilities. In some embodiments, a component (at least a portion of a memory sub-system, an interface coupled to the memory sub-system, or both) can be disabled, an erase operation of any data on the memory sub-system can be performed, and the component can be reenabled, as detailed herein. That is, memory access management employs at least disabling of the portion of the memory sub-subsystem, the interface coupled to the memory sub-system, or both, prior to performance of and/or in the absence of any erase operation being performed once an occurrence of an event (e.g., a power-up event and/or a remote “kill switch” has been triggered) has been detected. For instance, in some embodiments, memory access management (e.g., disabling and/or subsequently reenabling components, as detailed herein) is performed entirely in the absence of any signaling indicative of an erase operation (e.g., occurs in the absence of an erase operation).

In some embodiments, memory access management can perform an operation to reenable memory operations associated with at least a portion of the memory sub-system, an interface coupled to the memory sub-system, or both that is disabled responsive to receipt of signaling indicative of a vendor specific access code. For instance, a pin, an input sequence, and/or other form of code that is specific to the vendor of a non-volatile memory device can be provided to a non-volatile memory device to permit a disabled portion of a memory sub-system, a disabled interface coupled to the memory sub-system, or both, to be reenabled.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HUD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (MEV) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include various combinations of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) includes negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130, 140 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 130 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130. The memory sub-system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140.

In some embodiments, the memory device 130 includes local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 includes a memory access management component 113. Although not shown in FIG. 1 so as to not obfuscate the drawings, the memory access management component 113 can include various circuitry to facilitate detecting an occurrence of an event associated with a memory sub-system comprising blocks of non-volatile memory cells. Responsive to detecting the occurrence of the event, the memory access management component 113 can provide signaling to disable at least a portion of the memory sub-system, an interface coupled to the memory sub-system, or both. For instance, in some embodiments, the memory access management component 113 can include various circuitry to facilitate detecting a power-up event and responsive to detecting the occurrence of the power-up event, providing signaling to disable at least a portion of the memory sub-system, the interface coupled to the memory sub-system, or both. At least a portion of the memory sub-system, an interface (e.g., an input/output interface) coupled to the memory sub-system, or both can be disabled prior to any host activity (e.g., prior to the host system utilizing the interface coupled to the memory sub-system). Stated differently, disabling of a memory sub-system, an interface coupled to the memory sub-system, or both, can be performed prior to the host system performing initializing operations that involve the memory sub-system. Consequently, memory operations (e.g., read operations and/or write operations) to the memory sub-system can be disabled and thereby nefarious or otherwise unwanted access (e.g., read and/or write access) to any data stored on the memory sub-system can be prevented.

As mentioned, the memory access management component 113 can perform an operation to disable at least a portion of the memory sub-system, an interface coupled to the memory sub-system, or both, to prevent access to the blocks of non-volatile memory cells in the memory sub-system. Notably, performing an operation to disable at least a portion of the memory, sub-system, an interface coupled to the memory sub-system, or both, can effectively prevent access to each of the blocks of non-volatile memory cells in the memory sub-system without having to directly perform an operation on each of the blocks of non-volatile memory cells. As such, employing memory access management, as detailed herein, can thereby provide a quicker, more efficient mechanism to secure the data in each blocks of non-volatile memory cells in the memory sub-system as compared to other approaches such as those that attempt to erase data (e.g., by performing a block erase) on each block of memory cells in a memory sub-system.

In some embodiments, the memory access management component 113 can include special purpose circuitry in the form of an ASIC, FPGA, state machine, and/or other logic circuitry or software and/or firmware that can allow the memory access management component 113 to orchestrate and/or perform memory access management for the memory device 130 and/or the memory device 140.

In some embodiments, the memory sub-system controller 115 includes at least a portion of the memory access management component 113, For example, the memory sub-system controller 115 can include a processor 117 (processing device) configured to execute instructions stored in local memory 119 for performing the operations described herein. In some embodiments, the memory access management component 113 is part of the host system 120 (not illustrated), an application, or an operating system. In some embodiments, the memory device 130, the memory device 140, or both, includes at least a portion of the memory access management component 113.

In a non-limiting example, an apparatus (e.g., the computing system 100) can include a memory access management component 113. The memory access management component 113 can be resident on the memory sub-system 110. As used herein, the term “resident on” refers to something that is physically located on a particular component. For example, the memory access management component 113 being “resident on” the memory sub-system 110 refers to a condition in which the hardware circuitry that comprises the memory access management component 113 is physically located on the memory sub-system 110. The term “resident on” can be used interchangeably with other terms such as “deployed on” or “located on,” as referred to herein.

The memory access management component 113 can be configured to detect an occurrence of an event associated with a memory sub-system comprising blocks of non-volatile memory cells. For instance, an event can be an initiation of a power-up event of a memory sub-system and/or receipt of a signal indicative of initiation of a remote “kill switch” that is triggered such as when a device including the memory sub-system is deemed/reported to be lost/stolen, among other possible types of events. The memory access management component 113 can detect an occurrence of an event associated with a memory sub-system comprising a plurality of blocks of NAND memory cells. In some embodiments, the plurality of blocks of NAND memory cells can be superblocks. A superblock generally refers to a set of data blocks that span multiple memory dices that are written in interleaved fashion. As used herein, the terms “block,” “block of memory cells,” and/or “interleaved NAND memory blocks,” as well as variants thereof, can, given the context of the disclosure, be used interchangeably.

In some embodiments, an initial (i.e., default) configuration of a non-volatile memory device may prevent access to blocks of non-volatile memory cells. For instance, a portion of a memory sub-system, an interface coupled to the memory sub-system, or both, can be disabled as an initial configuration. Thereby access to data (e.g., confidential and/or manufacturer specific data) stored in blocks of non-volatile memory cells can be prevented as an initial configuration which can, for instance, protect the data during transit in a supply chain. In such embodiments, access to the blocks of non-volatile memory cells can be subsequently reenabled, as detailed herein. The non-volatile memory device can be reenabled when the non-volatile memory device (or a device including the non-volatile memory device) arrives at a destination point in the supply chain and/or responsive to input of a vendor specific access code, as detailed herein.

However, in some embodiments, providing signaling to disable at least a portion of the memory sub-system, an interface coupled to the memory sub-system, or both, can be provided responsive to detection of occurrence of an event. An event can be detected responsive to receipt of an input to the memory sub-system and/or a host system, a change in a condition of the memory device, or can be otherwise detected. For instance, aspects of memory access management can be performed responsive to an input such as an input indicating a device including a non-volatile memory array is lost/stolen. For instance, a remote “kill switch” can be triggered responsive to a device being reported lost/stolen and corresponding signaling can be sent to the lost/stolen device (e.g., via a wireless signal, for instance, via a wireless signal in the absence of a manual input to a device) to initiate memory access management and thereby prevent access to blocks of non-volatile memory cells. In such instances, employing memory access management can timely and effectively secure data on the lost/stolen device, in contrast to other approaches that do not employ, memory access management such as those which instead attempt to erase any data on the lost/stolen device (e.g., via a block erase).

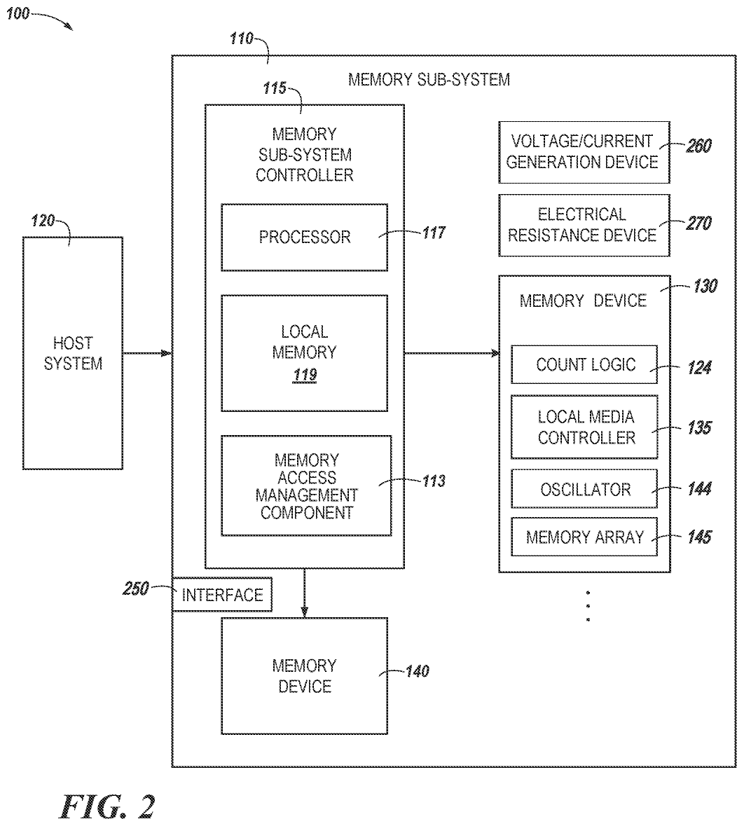

FIG. 2 illustrates another example computing system that includes a memory sub-system in accordance with some embodiments of the present disclosure. In various embodiments, the memory access management component 113 can detect initiation of a power-up event associated with a plurality of blocks of non-volatile memory cells of a memory sub-system, as detailed herein. For instance, the memory access management component can detect initiation of a power-up event, as detailed herein, associated with the host system 120, the memory sub-system 110, or both.

Responsive to detection of the initiation of the power-up event, memory access management component 113 can provide signaling to disable at least a portion of the memory sub-system 110, an interface such as interface 250 coupled to the memory sub-system, or both. The interface 250 can be a physical host interface, as describe herein. For instance, examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DEMI) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory system 110. The host system 120 can further utilize an NVM Express (NVMe) interface to access components (e.g., first memory device 130, second memory device 140) when the memory system 110 is coupled with the host system 120 by the PCIe interface. The physical host interface can provide an interface for passing control, address, data, and other signals between the memory system 110 and the host system 120.

In some embodiments, the memory access management component 113 can, responsive to detection of the occurrence of the power-up event, provide signaling to disable at least a portion of the memory sub-system, an interface coupled to the memory sub-system, or both, in the absence of signaling indicative of an erase operation associated with the plurality of blocks of non-volatile memory cells. Providing the signaling to disable at least the portion of the memory sub-system responsive to the detection of the occurrence of the power-up event and in the absence of signaling indicative of an erase operation, can timely prevent access to any data on the memory sub-system e.g., prior to a host system performing any access of the data on the memory, sub-system), in contrast to other approaches such as those that attempt to employ time consuming erase operations.

In some embodiments, the memory access management component 113 can perform an operation to disable some but not all of the components in the memory sub-system 110. For instance, at least one component in the memory sub-system 110 can be disabled to prevent access to the entire memory array 145 (e.g., an array of blocks of non-volatile memory cells) in the memory sub-system 110. For example, the memory access management component 113 can perform an operation to disable some but not all of the memory sub-system controller 115, the memory device 130/140, the interface 250, a voltage/current generation device 260, and/or an electrical resistance device 270. For instance, disabling the memory device 130/140) can entail disabling at least one component in the memory device 130/140 such as count logic 124, local media controller 135, an oscillator 144, the memory array 145 and/or another component included in the memory device 130/140. Disabling some but not all components in the memory sub-system 110 can reduce a quantity of operations (e.g., those to disable the respective components) which can reduce an amount of power consumption and/or reduce an amount of time to prevent access to any data on the non-volatile memory cells, and yet can prevent access to each of the blocks of non-volatile memory cells in the memory array 145.

In some embodiments, signaling can be provided to disable the voltage/current generation device 260 that is coupled to the memory sub-system 110. Disabling the voltage/current generation device 260 (e.g., a high-voltage generation pump) can prevent any memory operations from being performed by prohibiting any alteration or generation of voltage/current typically employed when performing a memory operation (e.g., a read operation).

In some embodiments, a plurality of components can be disabled. For instance, both a physical interface and at least a portion of the memory sub-system 110 (e.g., a high-voltage generation pump, a memory array, and/or a controller, etc.) can be disabled. Disabling two or more components can provide benefits such as redundancy and/or can mitigate any attempts to circumvent an individual disabled component and thereby gain unwanted access to any data stored on the memory sub-system 110.

In some embodiments, the memory access management component 113 can provide signaling to temporarily disable the memory sub-system 110, the interface 250, or both. As used herein, temporarily disabling refers to providing signaling that causes a reversible change (e.g., disabling a component that is subsequently reenabled). Various mechanisms such as changing a value of a bit, a status of a flag, and/or other mechanism can permit temporarily disabling the memory sub-system, the interface, or both. For instance, the memory access management component 113 can provide signaling to alter a value of a configuration bit to a first value responsive to the signaling to temporarily disable at least the portion of the memory sub-system, the interface coupled to the memory sub-system, or both. In such embodiments, the memory access management component 113 can provide signaling to alter a value of the configuration bit from the first value to a second value responsive to providing the signaling to reenable at least the portion of the memory sub-system, the interface coupled to the memory sub-system, or both. That is, subsequent to providing the signaling to temporarily disable the memory sub-system, the interface coupled to the memory sub-system, or both, the memory access management component 113 can provide signaling to reenable at least the portion of the memory sub-system, the interface coupled to the memory sub-system, or both. Reenabling the portion of the memory sub-system, the interface coupled to the memory sub-system, or both can reenable access (e.g., read, write, and/or erase access) to the blocks of non-volatile memory cells in the memory sub-system. For instance, an operation can be performed to reenable each portion of the memory sub-system and/or the interface that had been previously disabled and can thereby can reenable access to each (or subsets) of the blocks of non-volatile memory cells in the memory sub-system.

However, in some embodiments, the memory access management component 113 can provide signaling to permanently disable the memory sub-system 110, the interface 250, or both, and thereby permanently disable access to the memory sub-system 110. As used herein permanently disabling refers to providing signaling that causes an irreversible change. Various mechanisms can be employed to permanently disable the memory sub-system 110.

For instance, providing the signaling to permanently disable at least the portion of the memory sub-system, the interface coupled to the memory sub-system, or both, can include providing signaling to alter a status of an electrical resistance device 270. The electrical resistance device 270 can be coupled to the memory sub-system 110, the interface 250, or both. The electrical resistance device 270 can be a fuse and/or an anti-fuse. In some embodiments, the electrical resistance device 270 is an anti-fuse. In such embodiments, the memory access management component 113 can provide signaling to activate the anti-fuse and thereby permanently disable the memory sub-system 110, the interface 250, or both. However, other mechanisms to permanently disable the memory sub-system 110, the interface 250, or both, are possible. For instance, a dedicated bit or one-time programmable fuse can be changed responsive to detection of an event and thereby permanently disable the memory sub-system 110, the interface 250, or both, among other possibilities.

In some embodiments, memory array 145 can be non-volatile memory array such has a NAND memory array. The non-volatile memory array 145 can be resident on a mobile computing device such as a smartphone, laptop, phablet, Internet-of-Things device, autonomous vehicle, or the like. As used herein, the term “mobile computing device” generally refers to a handheld computing device that has a slate or phablet form factor. In general, a slate form factor can include a display screen that is between approximately 3 inches and 5.2 inches (measured diagonally), while a phablet form factor can include a display screen that is between approximately 5.2 inches and 7 inches (measured diagonally). Examples of “mobile computing devices” are not so limited, however, and in some embodiments, a “mobile computing device” can refer to an IoT device, among other types of edge computing devices.

As used herein, an enabled component (e.g., a portion of a memory sub-system and/or an interface coupled to the memory sub-system) can refer to component that permits normal operation and normal access to each of blocks of non-volatile memory cells in a memory array such as the memory array 145. As used herein, a disabled component can refer to a component that does not permit normal access (e.g., read access) to each of the blocks of non-volatile memory cells in a memory array such as the memory array 145.

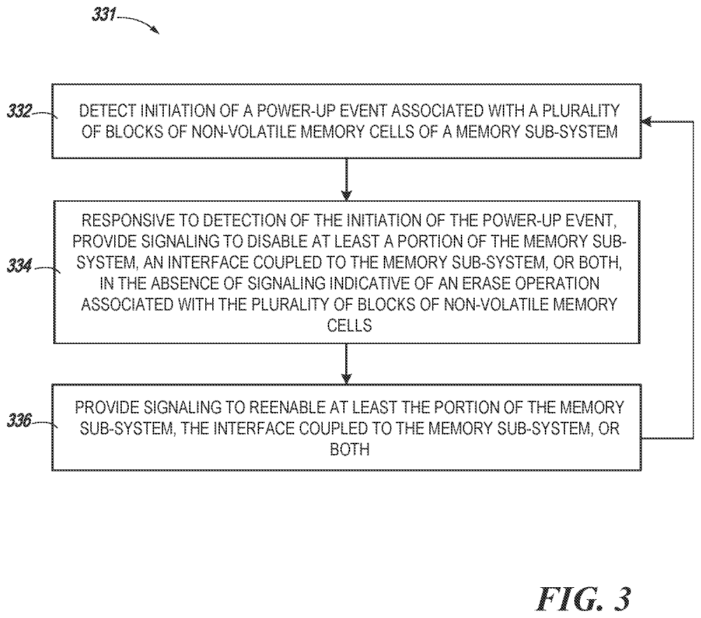

FIG. 3 illustrates an example flow diagram 331 of memory access management in accordance with some embodiments of the present disclosure. At operation 332, a memory access management component (such as memory access management component 113 in FIG. 1) can detect initiation of a power-up event associated with blocks of non-volatile memory cells of a memory sub-system. For instance, the memory access management component 113 can be configured to detect a power-up event associated with a memory sub-system comprising a blocks of memory cells (e.g., blocks of NAND memory cells).

A power-up event can be detected based on a change in an indicator/flag or other mechanism and/or based on a change in a voltage/current in or associated with a memory sub-system, among other possibilities. In some embodiments, the power-up event can be detected by components of the memory sub-system prior to and/or in the absence of receipt of memory sub-system initiation commands originating from a central processing unit of the host system (such as the host system 120 in FIG. 1). Accordingly, in some embodiments, the power-up event can be detected by components of the memory sub-system before the host system 120 propagates signals or asserts commands on the memory sub-system that invoke memory cells of the memory device. This can allow for the memory sub-system to perform the operations described herein.

Responsive to detection of initiation of the power-up event, the flow diagram 331 can proceed to operation 334. At operation 334, the memory access management component can provide signaling to disable at least a portion of the memory sub-system, an interface coupled to the memory sub-system, or both. For instance, the memory access management component can provide signaling to disable at least a portion of the memory sub-system, an interface coupled to the memory sub-system, or both, in the absence of signaling indicative of an erase operation associated with the plurality of blocks of non-volatile memory cells.

Responsive to providing the signaling to disable at 334, the flow diagram 331 can proceed to operation 336. At operation 336, the memory access management component can provide signaling to reenable at least the portion of the memory sub-system, the interface coupled to the memory sub-system, or both. As mentioned, such disabling and subsequent reenabling of access to non-volatile memory cells (e.g., when a lost device is found) can extend an operational and/or functional lifetime of a device and/or securely retain data, as compared to other approaches which do not employ memory access management such as those attempt to erase (e.g., via a block erase) all data on a device.

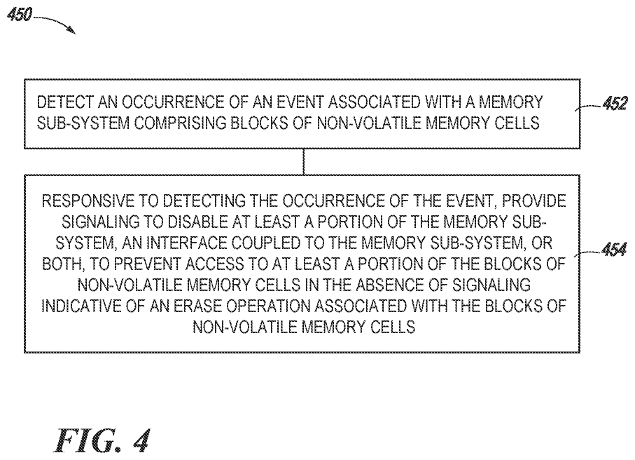

FIG. 4 is a flow diagram corresponding to a method 450 for memory access management in accordance with some embodiments of the present disclosure. The method 450 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 450 is performed by the memory access management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 452, an occurrence of an event associated with a memory sub-system comprising a plurality of blocks of non-volatile memory cells can be detected. The occurrence of the event can be detected at a beginning of usage of the memory system by a user, subsequent to manufacturing testing, at a particular life cycle in the usage of the memory system, and/or in response to a system condition/input, etc. For instance, the occurrence of the event can be determined prior to native use, or use by a user. As an example, the occurrence of the event can be determined during a testing and/or manufacturing phase of a memory sub-system.

However, in some embodiments the occurrence of the event can be identified in response to a change in a system condition and/or an input. Examples of changes to system conditions include changes to a status flag, a change in a value of a bit, and/or another type of change. For instance, responsive to a device in which the non-volatile memory device is included being stolen, a system condition (e.g., a value of a bit) can be changed. The change in the system condition can be detected as an occurrence of an event.

Responsive to detecting the occurrence of the event (e.g., the change in the system condition and/or receipt of an input), signaling can be provided to disable at least the portion of the memory sub-system, an interface coupled to the memory sub-system, or both. For instance, at operation 454 signaling can be provided to disable at least the portion of the memory sub-system, an interface coupled to the memory sub-system, or both, responsive to detection of the event at 452. In some embodiments, signaling can be provided to disable at least the portion of the memory sub-system, an interface coupled to the memory sub-system, or both, in the absence of signaling indicative of an erase operation associated with the plurality of blocks of non-volatile memory cells. Thus, in some embodiments, providing the signaling to disable at least the portion of the memory sub-system, an interface coupled to the memory sub-system, or both, can prevent access to at least a portion of the plurality of blocks of non-volatile memory cells in the absence of signaling indicative of an erase operation associated with the plurality of blocks of non-volatile memory cells, as compared to other approaches that may attempt to perform timing consuming/ineffective erase operations to erase data on a stolen device. As detailed herein, the access to the block of non-volatile memory cells can be temporarily or permanently disabled by way, of temporarily or permanently disabling a given component (e.g., least the portion of the memory sub-system, an interface coupled to the memory sub-system, or both).

For instance, in some embodiments, subsequent to providing the signaling to disable the memory sub-system, the interface coupled to the memory sub-system, or both, signaling can be provided to reenable at least the portion of the memory sub-system, the interface coupled to the memory sub-system, or both. That is, an operation to reenable at least the portion of the memory sub-system, an interface coupled to the memory sub-system, or both that had be previously disabled to prevent access to the blocks of non-volatile memory cells can be performed. Reenabling the portion of the memory sub-system, the interface coupled to the memory sub-system, or both can reenable access (e.g., read, write, and/or erase access) to the blocks of non-volatile memory cells in the memory sub-system. Thus, subsequent to providing the signaling to disable the memory sub-system, the interface coupled to the memory subsystem, or both, to prevent access to the blocks of non-volatile memory cells, signaling can be provided to reenable the portion of the memory sub-system, the interface coupled to the memory sub-system, or both, to reenable access to the blocks of non-volatile memory cells in the memory sub-system. For instance, an operation can be performed to reenable each portion of the memory sub-system and/or the interface that had been previously disabled and can thereby reenable access to each (or subsets) of the blocks of non-volatile memory cells in the memory sub-system.

In some embodiments, host data can be written to the blocks of non-volatile memory cells in the memory sub-system. For instance, in the above example of a lost or stolen device, the lost or stolen device (in which at least a portion of the memory sub-system, the interface coupled to the memory subsystem, or both and been disabled) can be recovered and subsequently access can be reenabled to permit performing a memory operation on and/or performing a host access involving host data written to blocks of non-volatile memory cells in the memory sub-system. However, in some embodiments at least a portion of the memory sub-system, an interface coupled to the memory sub-system, or both, can be permanently disabled, as detailed herein.

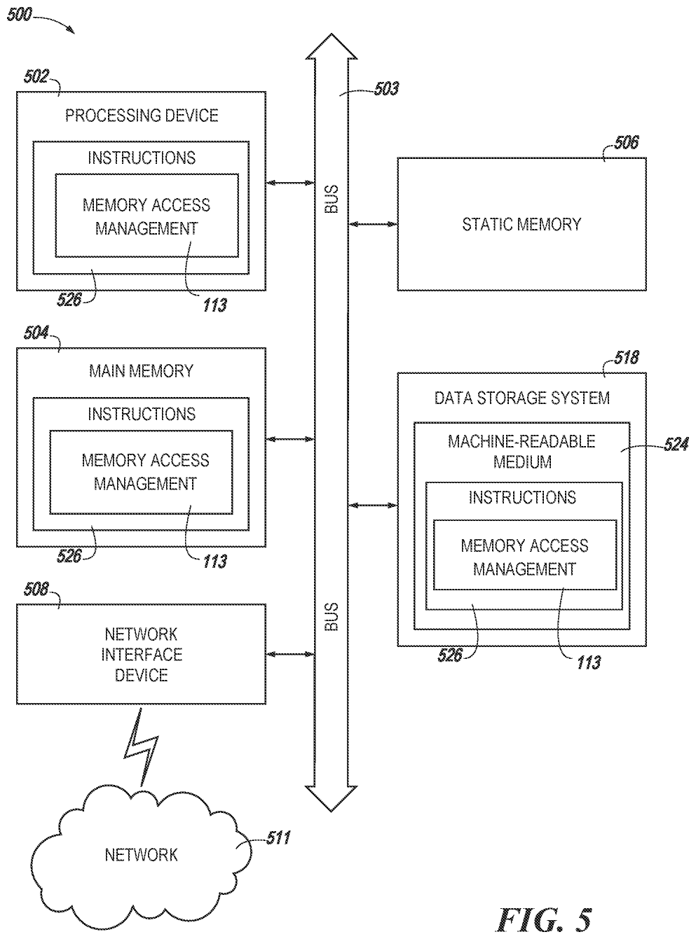

FIG. 5 is a block diagram of an example computer system 500 in which embodiments of the present disclosure may operate. For example, FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the memory access management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-tip-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 503.

The processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 511.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a memory access management component (e.g., the memory access management component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including solid state drives (SSDs), hard disk drives (HDDs), floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
detecting an occurrence of a power-up event associated with a memory sub-system comprising a plurality of blocks of non-volatile memory cells;
responsive to detecting the occurrence of the power-up event, providing signaling to temporarily disable at least a portion of the memory sub-system, an interface coupled to the memory sub-system, or both, prior to completion of the power-up event, wherein the signaling is configured to prevent access to data stored in at least a portion of the plurality of blocks of non-volatile memory cells in the absence of signaling indicative of an erase operation associated with the plurality of blocks of non-volatile memory cells;
providing signaling to reenable at least the portion of the memory sub-system, the interface coupled to the memory sub-system, or both; and
subsequent to reenabling at least the portion of the memory sub-system, the interface coupled to the memory sub-system, or both, performing a memory operation to access the data.

2.-3. (canceled)

4. The method of claim 1, further comprising:
altering a value of a configuration bit to a first value responsive to the signaling to temporarily disable at least the portion of the memory sub-system, the interface coupled to the memory sub-system, or both, and
altering the value of the configuration bit from the first value to a second value responsive to providing the signaling to reenable at least the portion of the memory sub-system, the interface coupled to the memory sub-system, or both.

5.-7. (canceled)

8. The method of claim 1, wherein providing the signaling to disable the at least the portion of the memory sub-system, the interface coupled to the memory sub-system, or both further comprises providing the signaling to disable at least the portion of the memory sub-system, the interface coupled to the memory sub-system, or both, to prevent read access, write access, or both, to at least the portion the plurality of blocks of non-volatile memory cells.

9. The method of claim 1, wherein the event is an initiation of a power-up event, and wherein providing the signaling to disable at least the portion of the memory sub-system, the interface coupled to the memory sub-system, or both further comprises providing the signaling to disable the at least the portion of the memory sub-system, the interface coupled to the memory sub-system, or both, responsive to detecting the initiation of the power-up event.

10. The method of claim 1, further comprising providing the signaling to disable at least the portion of the memory sub-system, the interface coupled to the memory sub-system, or both, as an initial configuration.

11. An apparatus, comprising:
a memory access management component configured to:
detect initiation of a power-up event associated with a plurality of blocks of non-volatile memory cells of a memory sub-system;
responsive to detection of the initiation of the power-up event, provide signaling to temporarily disable at least a portion of the memory sub-system, an interface coupled to the memory sub-system, or both, prior to completion of the power-up event in the absence of signaling indicative of an erase operation associated with data stored in the plurality of blocks of non-volatile memory cells;
provide signaling to reenable at least the portion of the memory sub-system, the interface coupled to the memory sub-system, or both; and
perform a memory operation to access the data stored in the plurality of blocks of non-volatile memory cells.

12. (canceled)

13. The apparatus of claim 11, wherein the memory access management component is further configured to provide signaling to disable a plurality of components in the apparatus.

14. The apparatus of claim 11, wherein the memory access management component is further configured to provide signaling to disable the interface.

15. The apparatus of claim 11, wherein the memory access management component is further configured to provide signaling to disable a voltage/current generation device coupled to the memory sub-system.

16. The apparatus of claim 11, wherein the memory access management component is further configured to provide signaling to disable a controller coupled to the memory sub-system.

17. A system, comprising:
a memory sub-system comprising a plurality of memory components arranged to form a stackable cross-gridded array of a plurality of blocks of interleaved non-volatile memory cells; and
a processing device coupled to the plurality of memory components, the processing device to perform operations comprising:
detecting initiation of a power-up event associated the memory sub-system;
responsive to detecting the power-up event, providing signaling to temporarily disable at least a portion of the memory sub-system, a physical interface coupled to the memory sub-system, or both prior to completion of the power-up event to prevent access to data in at least a portion of the blocks of interleaved non-volatile memory cells;
subsequent to providing the signaling to perform an erase operation, providing signaling to reenable at least the portion of the memory sub-system, the physical interface coupled to the memory sub-system, or both to permit access to the data in at least the portion of the blocks of interleaved non-volatile memory cells; and
performing a memory operation on the interleaved non-volatile memory cells to access the data.

18. The system of claim 17, wherein the processing device is further to provide the signaling to reenable at least the portion of the memory sub-system, the physical interface coupled to the memory sub-system, or both, responsive to receipt of signaling indicative of a vendor specific access code.

19. The system of claim 17, wherein the plurality of blocks of interleaved non-volatile memory cells are NAND memory cells in a NAND memory array resident on a mobile computing device.

20. (canceled)
